(19) United States
(12) Patent Application Publication
(10) Pub. No.: US 2025/0389291 A1
(43) Pub. Date: Dec. 25, 2025

(54) Fastener, Fastening Assembly and Vehicle

(71) Applicant: Illinois Tool Works Inc., Glenview, IL (US)

(72) Inventors: Zhilin Li, Shanghai (CN); Leyao Zhang, Shanghai (CN); Xiaojin Liu, Shanghai (CN)

(21) Appl. No.: 19/246,364

(22) Filed: Jun. 23, 2025

(30) Foreign Application Priority Data
Jun. 24, 2024 (CN) 202410821915.2
Jun. 20, 2025 (CN) 202510831578.X

(51) Int. Cl. F16B 21/02; F16B 21/08

(52) U.S. Cl. CPC F16B 21/02; F16B 21/086

(57) ABSTRACT

The disclosure describes a fastener used to connect a first and second component. The fastener includes a flat support portion and a first connecting portion. The connecting portion extends along the fastener's axis and has a side wall and a sealing section. The side wall extends from the edge of the support portion, and the sealing section extends from the outside of the side wall back toward the support portion but doesn't go beyond it. The sealing section is elastic and wraps around the side wall. When the fastener is compressed by the connected component, the elastic sealing section deforms to create a tight seal. This deformation also helps absorb manufacturing and assembly variations, making the fastener easier to produce and install.

### RELATED APPLICATIONS

The present application claims the benefit of Chinese Patent Application Nos. 202410821915.2, filed Jun. 24, 2024, titled “Fastener” and 202510831578.X, filed Jun. 20, 2025, titled “Fastener, Fastening Assembly and Vehicle,” the contents of which are hereby incorporated by reference.

### TECHNICAL FIELD

The present disclosure relates to a fastener for a vehicle, a fastening assembly comprising the fastener, and a vehicle comprising the fastening assembly.

### BACKGROUND

During the vehicle assembly process, fasteners can connect multiple components together, such as securing the interior components, frame, and panels of a vehicle together. Typically, a first component is first connected to the fastener to form a pre-assembled assembly. This assembly is then assembled into a corresponding hole or slot on the second component, thereby connecting the first and second components.

### SUMMARY OF THE DISCLOSURE

The present disclosure relates generally to a fastener, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastener according to one embodiment of the present disclosure from one perspective.

FIG. 1B is a perspective view of the fastener in FIG. 1A from another perspective.

FIG. 1C is a front view of the fastener in FIG. 1A.

FIG. 1D is a sectional view of the fastener in FIG. 1A, taken along line A-A in FIG. 1C.

FIG. 2 is an exploded view of the fastener in FIG. 1A with a first component and a second component.

FIG. 3A is a perspective view of the first component in FIG. 2 from one perspective.

FIG. 3B is a perspective view of the first component in FIG. 3A from another perspective.

FIG. 4A is a sectional view of a fastening assembly formed by pre-assembling the fastener in FIG. 1A with the first component in FIG. 3A, in a state where the fastener is located at a first position within the first component.

FIG. 4B is a sectional view of the fastening assembly in FIG. 4A in another state, where the fastener is located at a second position within the first component.

FIG. 5A is a perspective view showing the fastening assembly in FIG. 4A inserted into the second component but not yet fastened.

FIG. 5B is a perspective view showing the fastening assembly in FIG. 4A fastened to the second component.

FIG. 5C is a sectional view showing the fastening assembly in FIG. 4A fastened to the second component.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC). The processor may be coupled to or integrated with a memory device. The memory device can be any suitable type of computer memory or any other type of electronic storage medium, such as, for example, read-only memory (ROM), random access memory (RAM), cache memory, compact disc read-only memory (CD-ROM), electro-optical memory, magneto-optical memory, programmable read-only memory (PROM), erasable programmable read-only memory (EPROM), electrically erasable programmable read-only memory (EEPROM), a computer-readable medium, or the like.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Embodiments of the present disclosure provide a fastener for connecting a first component and a second component, such as connecting an interior trim panel of a vehicle to a sheet metal part, and capable of forming a seal between the fastener and the first component.

After long term observation and study, it has been noticed, in some existing fasteners, due to design configurations and/or tolerances arising from manufacturing and/or assembly processes, it can be difficult to assemble the fastener with the first component and/or achieve an effective seal between them.

According to a first aspect of the present disclosure, a fastener for connecting to a first component and a second component is provided. The fastener includes a support portion and a first connecting portion. The support portion is substantially plate-shaped. The first connecting portion extends substantially along an axis of the fastener and includes a side wall portion and a sealing portion. The side wall portion extends from an edge of the support portion in a direction away from the support portion. The sealing portion extends from an outer side of the side wall portion away from the side wall portion and toward the support portion without exceeding the support portion. The sealing portion continuously extends in a circumferential direction of the side wall portion. The sealing portion is elastic.

In some embodiments, the sealing portion includes a base connected to the side wall portion and a distal end away from the side wall portion. A thickness of the sealing portion gradually decreases from the base toward the distal end.

In some embodiments, the sealing portion includes a radially outer surface and a radially inner surface. The radially outer surface extends obliquely outward in a direction toward the support portion and away from the axis, or extends substantially parallel to the axis. The radially inner surface extends obliquely outward in a direction toward the support portion and away from the axis.

In some embodiments, the first connecting portion includes a plurality of the sealing portions. The plurality of sealing portions are arranged spaced apart along the axis.

In some embodiments, the side wall portion extends obliquely outward in a direction away from the support portion and away from the axis.

In some embodiments, the faster further includes a second connecting portion. The second connecting portion is connected to the support portion and extends substantially along the axis. The support portion has opposing first and second sides, the first connecting portion is located at the first side, the second connecting portion is located at the second side, and the second connecting portion is configured to cooperate with the support portion to clamp the first component and the second component.

In some embodiments, the fastener is integrally formed from a thermoplastic material.

According to a second aspect of the present disclosure, a fastening assembly for fastening to a second component is provided. The fastening assembly includes the fastener according to the first aspect and a first component. The first component is connected to the fastener and includes a sealing mating portion. The fastening assembly has a fastened state in which the sealing mating portion presses against the sealing portion to elastically deform the sealing portion, thereby forming a seal between the fastener and the first component.

According to a third aspect of the present disclosure, a vehicle is provided. The vehicle includes the fastener according to the first aspect or the fastening assembly according to the second aspect.

The first connecting portion of the present disclosure includes an elastic sealing portion, which readily undergoes elastic deformation under compression by the connected component to form an effective sealed connection between the fastener and the connected component. Additionally, the elastic deformation of the sealing portion can compensate for tolerances due to manufacturing and/or assembly, making the fastener and the connected component easier to manufacture and assemble.

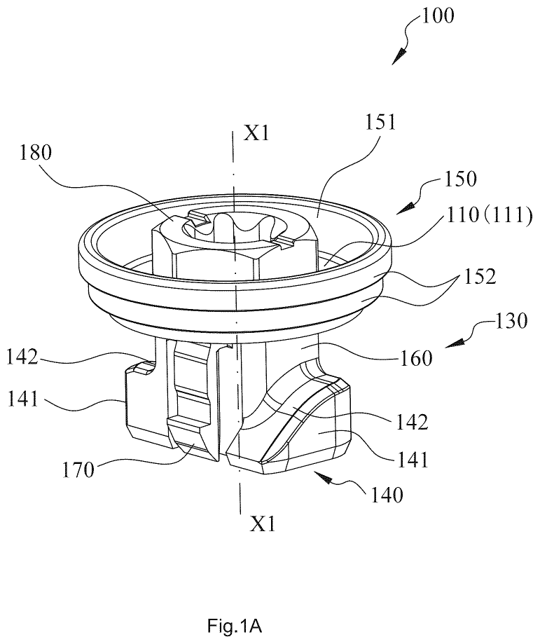

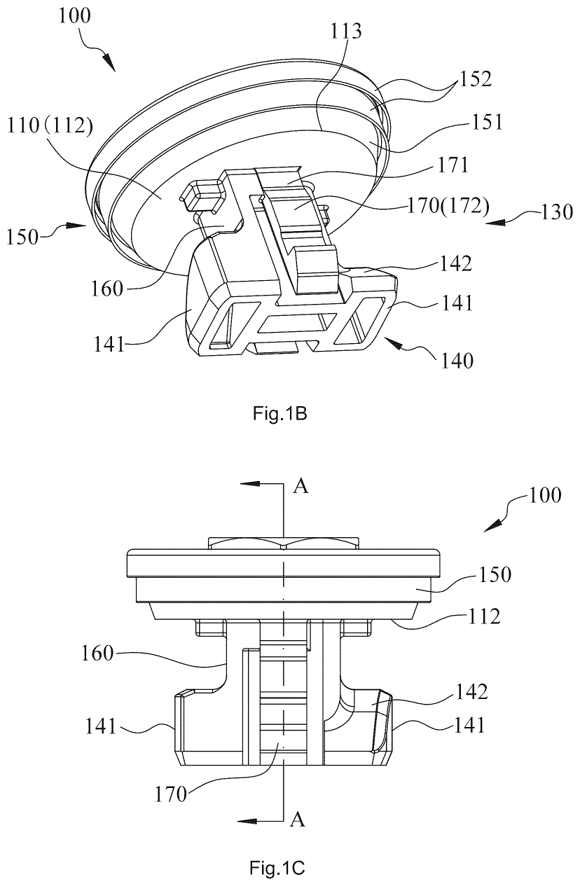

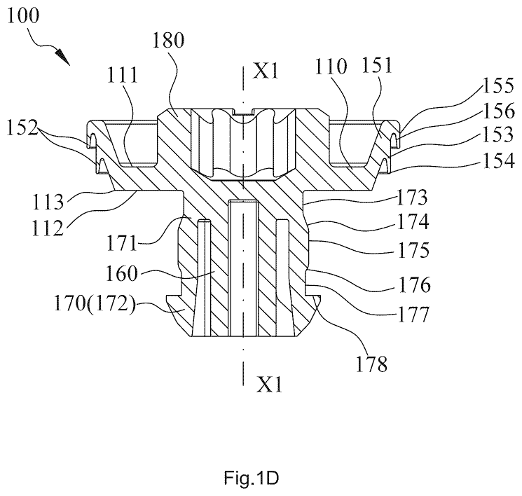

FIGS. 1A-1D illustrate the specific structure of a fastener 100 according to one embodiment of the present disclosure. FIG. 1A is a perspective view of the fastener 100 from one perspective, FIG. 1B is a perspective view of the fastener 100 in FIG. 1A from another perspective, FIG. 1C is a front view of the fastener 100 in FIG. 1A, and FIG. 1D is a sectional view of the fastener 100 in FIG. 1A taken along line A-A in FIG. 1C.

As shown in FIGS. 1A-1D, the fastener 100 includes a support portion 110, a first connecting portion 150, a second connecting portion 130, and an operating portion 180. The support portion 110 is substantially a circular plate-like structure and has a central axis X1 of the fastener 100 as its axis. In the axial direction of the support portion 110, it has opposing first and second sides 111, 112, the surfaces of which both extend radially relative to the support portion 110. The first connecting portion 150 is located on the first side 111. The first connecting portion 150 is connected to the circumferential edge 113 of the support portion 110 and extends substantially along the central axis X1 away from the support portion 110. The second connecting portion 130 is connected to a central area of the second side 112 of the support portion 110 and extends substantially along the central axis X1 away from both the support portion 110 and the first connecting portion 150. The operating portion 180 is connected to the first side 111 of the support portion 110 and is surrounded by the first connecting portion 150. In some embodiments, the fastener 100 is integrally formed from a thermoplastic material.

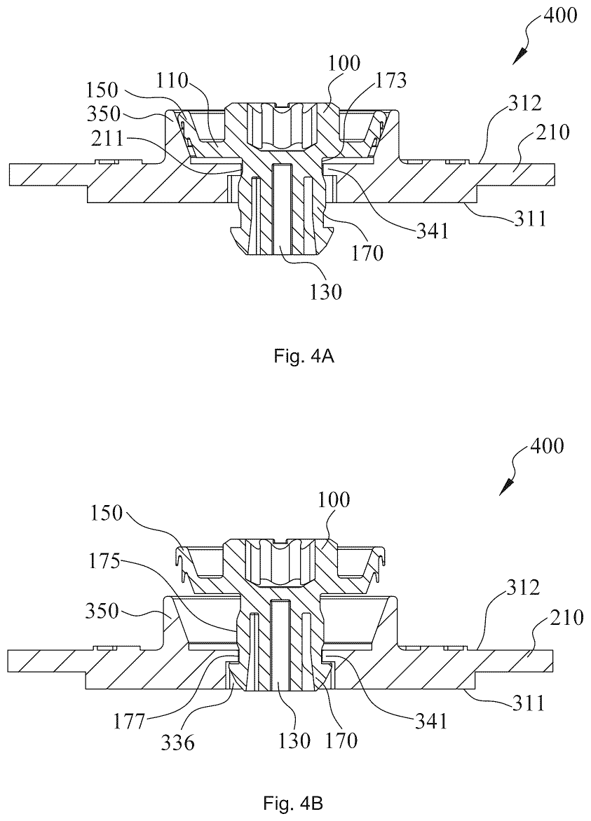

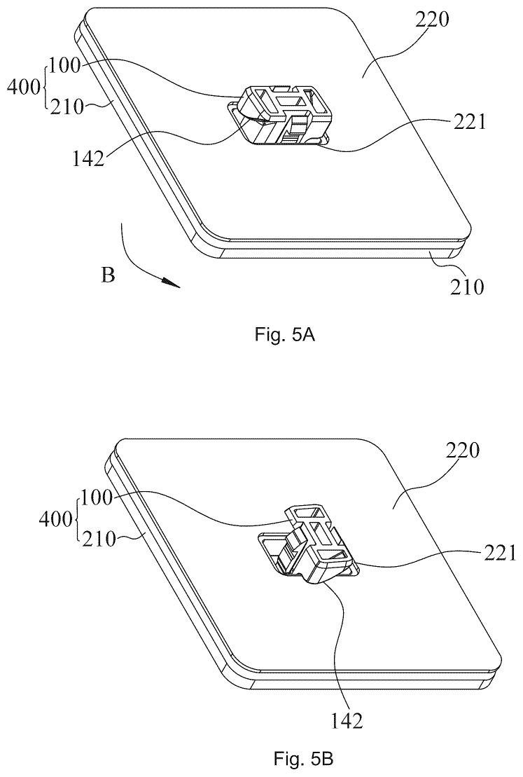

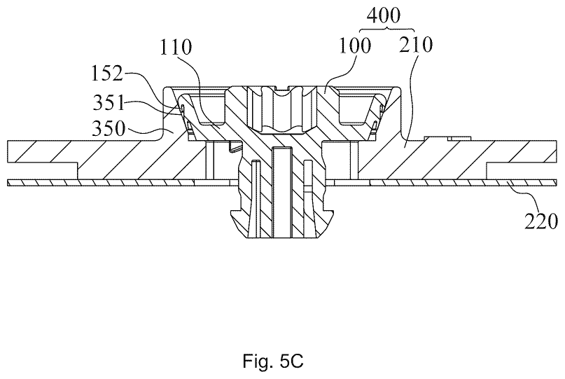

As will be described in detail below, when using the fastener 100 to connect the first and second components, the fastener 100 is first pre-assembled on the first component 210 to form a fastening assembly 400 (as shown in FIG. 4A). This fastening assembly 400 is then assembled onto the second component 220 (as shown in FIGS. 5B and 5C), thereby securely connecting the first component 210 and the second component 220 via the fastener 100. The first connecting portion 150 is configured to cooperate with corresponding parts of the first component 210 to form a seal between the fastener 100 and the first component 210. The second connecting portion 130 is configured to be inserted into corresponding holes or slots in the first component 210 and second component 220 and, in cooperation with the support portion 110, to clamp the first component 210 and the second component 220 together. The operating portion 180 is configured to cooperate with a driving tool (not shown) to drive (e.g., rotate) the fastener 100.

As shown in FIGS. 1A-1D, the first connecting portion 150 includes a side wall portion 151 and a sealing portion 152. The side wall portion 151 is connected to the circumferential edge 113 of the support portion 110 and extends obliquely outward away from the support portion 110 and away from the central axis X1.

In the illustrated embodiment, the support portion 110 is substantially a circular plate-like structure, and the side wall portion 151 of the first connecting portion 150 is substantially a hollow truncated cone. In other unillustrated embodiments, the side wall portion may extend substantially parallel to the central axis forming a hollow cylindrical shape, or the support portion and first connecting portion may be configured in other shapes.

As shown in FIGS. 1A-1D, the sealing portion 152 is connected to the radially outer side of the side wall portion 151 and extends away from the side wall portion 151 and towards the support portion 110. The sealing portion 152 extends continuously around the circumference of the side wall portion 151 and is elastic, capable of deforming under compression to cooperate with corresponding parts of the first component 210 to form a seal, as detailed later. In the direction of the central axis X1, there is a spacing between the sealing portion 152 and the second side 112 of the support portion 110. In other words, the sealing portion 152 does not extend beyond the support portion 110.

The sealing portion 152 includes a base 153 connected to the side wall portion 151 and a tip end 154 distal from the side wall portion 151. The thickness of the sealing portion 152 gradually decreases from the base 153 towards the tip end 154 to facilitate deformation. In the illustrated embodiment, the radially outer surface 155 of the sealing portion 152 extends substantially parallel to the direction of the central axis X1, while the radially inner surface 156 extends obliquely outward towards the support portion 110 and away from the central axis X1. In other unillustrated embodiments, both the radially outer surface 155 and radially inner surface 156 of the sealing portion 152 may extend obliquely outward towards the support portion 110 and away from the central axis X1.

As shown in FIGS. 1A-1D, in the illustrated embodiment, the first connecting portion 150 includes two sealing portions 152 spaced apart in the direction of the central axis X1. In other unillustrated embodiments, only one sealing portion 152 or more than two sealing portions 152 may be provided.

As shown in FIGS. 1A-1D, the second connecting portion 130 includes a main body portion 160, a foot portion 140, and two arm portions 170. The main body portion 160 extends substantially along the central axis X1 and includes axially opposing ends. One end is connected to the support portion 110 and the arm portions 170, while the other end is connected to the foot portion 140. The arm portions 170 extend from the one end of the main body portion 160 away from the support portion 110.

As shown in FIGS. 1A-1D, the foot portion 140 includes two protrusions 141 that bulge outward relative to the main body portion 160 away from the central axis X1. The protrusions 141 each have a substantially wedge-shaped structure and include an inclined surface 142 obliquely facing the support portion 110. Viewed from one lateral side of the fastener 100, the thicker and thinner sides of each protrusion 141 are located on opposite sides of the central axis X1. The foot portion 140 is substantially rotationally symmetric about the central axis X1, with the two protrusions 141 located on opposite sides of the foot portion 140, and their inclined surfaces 142 have different orientations. The inclined surfaces 142 are configured to cooperate with the support portion 110 to clamp the first component 210 and the second component 220 together, as detailed later.

The arm portions 170 are used to retain the fastener 100 within the first component 210, as detailed later. As shown in FIGS. 1A-1D, the two arm portions 170 are symmetrically arranged about the central axis X1 of the fastener 100 and are circumferentially offset from the two protrusions 141. Each arm portion 170 includes a fixed portion 171 and a movable portion 172. The fixed portion 171 is connected to the main body portion 160. The movable portion 172 is spaced apart from the main body portion 160 by a gap and is deflectable towards and away from the main body portion 160.

As shown in FIG. 1D, the outer side of the arm portion 170, away from the central axis X1, includes an upper recess 173, a transition portion 175, a lower recess 177, and a stopping surface 178 which are arranged substantially along the direction of the central axis X1 from top to bottom. The stopping surface 178 extends substantially transversely to the central axis X1 near the free end of the arm portion 170 and faces the support portion 110. The lower recess 177 is formed between the stopping surface 178 and the transition portion 175. The upper recess 173 is formed between the support portion 110 and the transition portion 175. The upper recess 173 includes an upper guide surface 174. The upper guide surface 174 extends obliquely from the upper end of the transition portion 175 towards the support portion 110 and towards the central axis X1. The lower recess 177 includes a lower guide surface 176. The lower guide surface 176 extends obliquely from the lower end of the transition portion 175 away from the support portion 110 and towards the central axis X1.

As will be described in detail below, after the fastener 100 is pre-assembled into the first component 210, if the second connecting portion 130 is subjected to a corresponding external force, the fastener 100 can move axially relative to the first component 210. The upper guide surface 174 and lower guide surface 176 guide corresponding mating portions of the first component 210 to move between the upper recess 173 and the lower recess 177. The stopping surface 178 prevents the fastener 100 from disengaging from the first component 210.

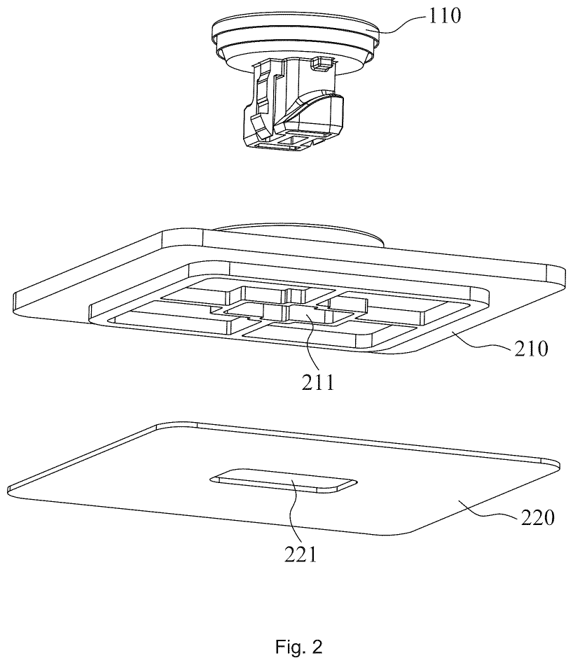

FIG. 2 is an exploded view of the fastener 100 in FIG. 1A with the first component 210 and the second component 220. In one embodiment of the present disclosure, the first component 210 is a vehicle door module, and the second component 220 is a vehicle door sheet metal part. For clarity in illustrating the fastener 100 of the present disclosure, the structures of the first component 210 and the second component 220 are shown simplified in the figures.

As shown in FIG. 2, the fastener 100 is used to connect the first component 210 and the second component 220. The first component 210 has a substantially rectangular first opening 211. The second component 220 has a substantially rectangular second opening 221. To connect the first component 210 and the second component 220, the fastener 100 is first inserted into the first opening 211 of the first component 210, so that the fastener 100 is pre-assembled on the first component 210. The fastener 100, now connected to the first component 210, is then inserted into the second opening 221 of the second component 220. Subsequently, the fastener 100 is rotated so that the two inclined surfaces 142 of the foot portion 140 abut against the second component 220, thereby securely connecting the first component 210 and the second component 220 via the fastener 100.

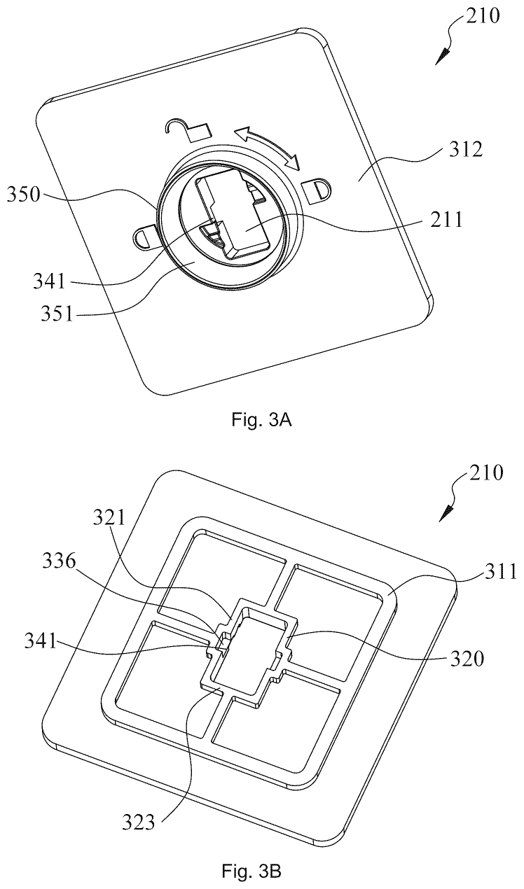

FIG. 3A is a perspective view of the first component 210 in FIG. 2 from one perspective. FIG. 3B is a perspective view of the first component 210 in FIG. 3A from another perspective. As shown in FIGS. 3A and 3B, the first component 210 is substantially plate-like and has opposing first and second sides 311, 312. The first opening 211 is substantially rectangular and penetrates through the first and second sides 311, 312. The first side 311 includes a flange portion 320 surrounding the first opening 211, which is raised above the surface of the first side 311. The first opening 211 has two long sides 321 extending along its length direction and two short sides 323 extending along its width direction. When inserting the fastener 100 into the first opening 211, the two long sides 321 correspond to the two arm portions 170 of the fastener 100, respectively.

The first component 210 further includes two accommodating portions 336, located at the two long sides 321 respectively, and communicating with the first opening 211. The accommodating portions 336 are recessed from the end face of the flange portion 320 towards the second side 312 and are spaced apart from the second side 312. The accommodating portions 336 are configured to accommodate the arm portions 170 of the fastener 100. A connecting mating portion 341 is formed between the bottom of each accommodating portion 336 and the second side 312. The connecting mating portion 341 can engage with the upper recess 173 and lower recess 177 of the arm portion 170.

The first component 210 also includes a sealing mating portion 350 connected to the second side 312 of the first component 210 and arranged surrounding the first opening 211. The inner side of the sealing mating portion 350 facing the first opening 211 has an annular wall 351. The size and shape of the annular wall 351 match those of the side wall portion 151 of the first connecting portion 150 of the fastener 100. Thus, when the fastener 100 connects the first component 210 and the second component 220, a small gap is formed between the annular wall 351 and the side wall portion 151 of the first connecting portion 150, and the sealing mating portion 350 compresses the sealing portion 152 of the first connecting portion 150 causing it to deform elastically, thereby forming a seal between the first connecting portion 150 and the sealing mating portion 350.

FIG. 4A is a sectional view of a fastening assembly 400 formed by pre-assembling the fastener 100 in FIG. 1A with the first component 210, in a state where the fastener 100 is at a first position within the first component 210. FIG. 4B is a sectional view of the fastening assembly 400 in FIG. 4A in another state, where the fastener 100 is at a second position within the first component 210.

As shown in FIG. 4A, when the fastener 100 is inserted into the first opening 211 of the first component 210 from the second side 312 of the first component 210 and reaches the first position relative to the first component 210, the first connecting portion 150 of the fastener 100 enters the sealing mating portion 350 of the first component 210. The two connecting mating portions 341 of the first component 210 are respectively retained in the two upper recesses 173 of the fastener 100. The second connecting portion 130 of the fastener 100 extends beyond the first side 311 of the first component 210.

During the process of connecting the fastening assembly 400 to the second component 220, situations may arise where the second connecting portion 130 of the fastener 100 is not yet aligned with the second opening 221 of the second component 220 and is blocked by the second component 220. In this case, if a force is applied to bring the first component 210 and the second component 220 closer together, the fastener 100 will move relative to the first component 210 away from the second component 220.

As shown in FIGS. 4A and 4B, when the second connecting portion 130 of the fastener 100 at the first position shown in FIG. 4A is subjected to an upward force in the orientation shown in FIGS. 4A and 4B, the arm portions 170 of the second connecting portion 130 are pressed inward by the connecting mating portions 341, causing the transition portion 175 of each arm portion 170 to be able to move upward past the connecting mating portion 341. This allows the fastener 100 to reach the second position shown in FIG. 4B. In this position, the two connecting mating portions 341 of the first component 210 are respectively retained in the two lower recesses 177 of the fastener 100.

It can be understood that when the fastener 100 moves relative to the first component 210 away from the first position, the connecting mating portion 341 may align with any position between the transition portion 175 and the lower recess 177. The lower recess 177 is the farthest position the connecting mating portion 341 can reach.

In the position shown in FIG. 4B, the second connecting portion 130 is substantially flush with the first side 311 of the first component 210, thus not hindering the bringing together of the first component 210 and the second component 220. When the second connecting portion 130 is aligned with the second opening 221 of the second component 220, the second connecting portion 130 is no longer subjected to the upward force, allowing the fastener 100 to move downward and return to the position where the upper recess 173 of the fastener 100 engages with the connecting mating portion 341 of the first component 210. At this point, the second connecting portion 130 passes through the second opening 221.

FIG. 5A is a perspective view showing the fastening assembly 400 in FIG. 4A inserted into the second component 220 but not yet fastened. FIG. 5B is a perspective view showing the fastening assembly 400 in FIG. 4A fastened to the second component 220. FIG. 5C is a sectional view showing the fastening assembly 400 in FIG. 4A fastened to the second component 220.

As shown in FIG. 5A, when the fastener 100, already connected to the first component 210, is just inserted into the second opening 221 of the second component 220, the inclined surfaces 142 of the fastener 100 do not yet abut against the surface of the second component 220, and the fastener 100 has not yet locked the first component 210 and the second component 220 together. A driving tool is then used to apply force to the operating portion 180, causing the fastener 100 to rotate counterclockwise as indicated by arrow B in FIG. 5A, bringing the fastener 100 to the position shown in FIG. 5B. At this point, the inclined surfaces 142 abut against the surface of the second component 220, and the first component 210 abuts against the second side 112 of the support portion 110. Consequently, the first component 210 and the second component 220 are held between the inclined surfaces 142 and the support portion 110, thereby securely connecting the first component 210 and the second component 220 via the fastener 100. Rotating the fastener 100 changes the position where the inclined surfaces 142 contact the second component 220, thereby pushing the first component 210 and the second component 220 closer to the support portion 110. This allows adjusting the angle of the fastener 100 to achieve a suitable clamping force between the first component 210 and the second component 220.

As shown in FIG. 5C, when the fastener 100 securely connects the first component 210 and the second component 220, the fastening assembly 400 is in its fastened state. Compared to the state shown in FIG. 4A, the side wall portion 151 of the first connecting portion 150 of the fastener 100 moves closer to the sealing mating portion 350 of the first component 210, forming a smaller gap between it and the annular wall 351 of the sealing mating portion 350. The sealing mating portion 350 of the first component 210 compresses the sealing portion 152 of the first connecting portion 150, causing it to deform elastically. This forms a seal between the first connecting portion 150 and the sealing mating portion 350, preventing fluid at two sides of the first component 210 and second component 220 from communicating through the first opening 211 and second opening 221. Furthermore, the elastic deformation of the sealing portion 152 can compensate for tolerances arising from manufacturing and/or assembly.

The present disclosure also protects a vehicle including the fastener, the first component, and the second component as described above, or including the fastening assembly and the second component as described above.

The first connecting portion of the fastener according to the embodiments of the present disclosure includes an elastic sealing portion, which readily undergoes elastic deformation under compression by the connected component to form an effective sealed connection between the fastener and the connected component. Additionally, the elastic deformation of the sealing portion can compensate for tolerances due to manufacturing and/or assembly, making the fastener and the connected component easier to manufacture and assemble.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### MAIN REFERENCE SIGNS

100: Fastener
110: Support portion
111: First side
112: Second side
113: Circumferential edge
130: Second connecting portion
140: Foot portion
141: Protrusion
142: Inclined surface
150: First connecting portion
151: Side wall portion
152: Sealing portion
153: Base
154: Tip end
155: Radially outer surface
156: Radially inner surface
160: Main body portion
170: Arm portion
171: Fixed portion
172: Movable portion
173: Upper recess
174: Upper guide surface
175: Transition portion
176: Lower guide surface
177: Lower recess
178: Stopping surface
180: Operating portion
210: First component
211: First opening
220: Second component
221: Second opening
311: First side
312: Second side
320: Flange portion
321: Long side
323: Short side
336: Accommodating portion
341: Connecting mating portion
350: Sealing mating portion
351: Annular wall
400: Fastening assembly.

What is claimed is:

1. A fastener for connecting a first component and a second component, comprising:
a support portion being substantially plate-shaped; and
a first connecting portion extending substantially along an axis of the fastener and comprising:
a side wall portion extending from an edge of the support portion in a direction away from the support portion; and
a sealing portion extending from an outer side of the side wall portion away from the side wall portion and toward the support portion without exceeding the support portion, wherein the sealing portion extends continuously in a circumferential direction of the side wall portion, and wherein the sealing portion is elastic.

2. The fastener according to claim 1,
wherein the sealing portion comprises a base connected to the side wall portion and a distal end away from the side wall portion; and
wherein a thickness of the sealing portion gradually decreases from the base toward the distal end.

3. The fastener according to claim 1, wherein the sealing portion comprises a radially outer surface and a radially inner surface, wherein the radially outer surface extends obliquely outward in a direction toward the support portion and away from the axis, or extends substantially parallel to the axis, and wherein the radially inner surface extends obliquely outward in a direction toward the support portion and away from the axis.

4. The fastener according to claim 1, wherein the first connecting portion comprises a plurality of the sealing portions, the plurality of sealing portions being arranged spaced apart along the axis.

5. The fastener according to claim 1, wherein the side wall portion extends obliquely outward in a direction away from the support portion and away from the axis.

6. The fastener according to claim 1, further comprising:
a second connecting portion connected to the support portion and extending substantially along the axis;
wherein the support portion has opposing first and second sides, the first connecting portion is located at the first side, the second connecting portion is located at the second side, and the second connecting portion is configured to cooperate with the support portion to clamp the first component and the second component.

7. The fastener according to claim 1, wherein the fastener is integrally formed from a thermoplastic material.

8. A fastening assembly for fastening to a second component, comprising:
the fastener according to claim 1; and
a first component connected to the fastener and comprising a sealing mating portion, wherein the fastening assembly has a fastened state in which the sealing mating portion presses against the sealing portion to elastically deform the sealing portion, thereby forming a seal between the fastener and the first component.

9. A vehicle, comprising the fastener according to claim 1.

10. A vehicle, comprising the fastening assembly according to claim 8.
